(19) United States
(12) Patent Application Publication
(10) Pub. No.: US 2011/0271225 A1
(43) Pub. Date: Nov. 3, 2011

(54) System and Method for Configuring Identification Codes

(76) Inventors: Craig Ronald Van Roy, Los Gatos, CA (US); William D. Diacont, Currituck, NC (US); Daniel Ross MacDougall, Durham, NC (US)

(21) Appl. No.: 13/097,897

(22) Filed: Apr. 29, 2011

Related U.S. Application Data
(60) Provisional application No. 61/329,792, filed on Apr. 30, 2010.

(51) Int. Cl. G06F 3/048

(52) U.S. Cl. 715/780; 715/810

(57) ABSTRACT

A system and method for configuring identification codes associated with electronic records is disclosed. In an exemplary embodiment, a user interface enables a user to create or edit an identification code configuration by displaying identification code characteristics and receiving corresponding identification code characteristic selections. The identification code characteristics include information segments, separators, and identification code types. The identification code characteristic selections are stored in a database or other data storage structure so as to define the identification code configuration. Preferably, the identification code configuration is used to generate a plurality of identification codes each of which is associated with and provides information about an electronic record.

### CROSS-REFERENCE TO RELATED APPLICATIONS

This application is based on and claims priority to U.S. Provisional Application Ser. No. 61/329,792, filed on Apr. 30, 2010, which is incorporated herein by reference in its entirety.

### STATEMENT REGARDING FEDERALLY SPONSORED RESEARCH OR DEVELOPMENT

Not applicable.

### BACKGROUND OF THE INVENTION

Many businesses and other entities, such as a secretary of state office, receive, generate, and track vast amounts of documents and other information. This information is typically stored as electronic records in an information management system. Identification codes have traditionally been used to facilitate information management wherein a unique identification code is associated with each electronic record in the system. The software that generates the identification codes does not accommodate an office that processes many different types of electronic records, each of which may require a different type of identification code.

### BRIEF SUMMARY OF THE INVENTION

A system and method for configuring identification codes associated with electronic records is disclosed. In an exemplary embodiment, the system includes at least one application server in communication with at least one database server. The application server provides a user interface that enables a user to create or edit an identification code configuration. To do so, the user interface displays a variety of identification code characteristics and receives the user's selection for each identification code characteristic. The identification code characteristic selections are stored in a database on the database server so as to define the identification code configuration. The identification code configuration is then used to generate an identification code for an electronic record, wherein the identification code is stored in association with the electronic record in the database server.

The identification code characteristics for each identification code configuration include an identification code type, one or more information segments, and one or more separators. The identification code type is used to identify the identification code configuration and may comprise an identification code configuration name, an office in which an identification code configuration is used, a line of business in which an identification code configuration is used, and an electronic record type for which an identification code configuration is used. Each of the information segments is configured to provide information about an electronic record without having to view or otherwise access the record. A separator, such as a dash or a space, may be used to separate adjacent information segments in an identification code. Alternatively, the information segments may be presented in a contiguous fashion.

The information segments for each identification code configuration provide, information about an electronic record and may include various types and combinations of information, such as a system date (e.g., any date entered into or captured by the system, including, but not limited to, a filing date, an arrival date, a process date, a completion date, a payment date, an application date, or a registration date), a sequential number, a batch designation (e.g., name, number, or other identifying code such as a folder batch number or financial batch number), a character string, a user designation (e.g., a user ID), an organization designation, a file designation, a document designation (e.g., an invoice number, a receipt number, a registration number, an application number, or document type), a party designation (e.g., a client, customer, or other relevant party name, number, or other identifying code), a matter designation, a folder designation, a system time (e.g., any time entered into or captured by the system), a payment designation (e.g., payment type or method), a filing method, a request type, and a product type. Of course, other types of information may be included in the information segments. Importantly, the information provided in the information segments can vary from configuration to configuration. Thus, an office that handles a wide variety of information can generate identification codes that are meaningful and appropriate for each of the various types of electronic records.

### BRIEF DESCRIPTION OF THE DRAWINGS

FIG. 1 is a diagram of a system for configuring identification codes associated with electronic records in accordance with an exemplary embodiment of the present invention.

FIG. 2 is a process flow diagram of an exemplary method for configuring identification codes using the system of FIG. 1.

FIGS. 3-5 are exemplary screen shots of a display device of FIG. 1 during the identification code configuration process.

### DETAILED DESCRIPTION OF EXEMPLARY EMBODIMENT

The present invention is directed to a system and method for configuring identification codes associated with the electronic records of a particular office or organization, such as a secretary of state office. While the invention will be described in detail below with reference to an exemplary embodiment, it should be understood that the invention is not limited to the specific system configuration or methodology of this embodiment. In addition, although the exemplary embodiment is described as embodying several different inventive features, one skilled in the art will appreciate that any one of these features could be implemented without the others in accordance with the invention.

As used throughout this specification and in the claims, the term “electronic record” means any information or object that is received, created, generated, processed, tracked, used, or otherwise accounted for and stored in an information management system of an office or organization. The term “information management system” means any system that provides organization of and control over the structure, processing and delivery of information. Without limiting the generality of the foregoing, the types of electronic records that may be stored in an information management system include: (i) an electronic document; (ii) information relating to an electronic or physical document (e.g., filing date, applicant name, document type, file number, payment information, line item); and (iii) information that is generated, created, or used by an office while processing or tracking another electronic record (e.g., registration number, completion date, notification or other correspondence). In addition, an electronic record as used herein encompasses any object that is part of an information management system, such as information relating to files, folders, batches, or other logical groupings. Of course, other types of electronic records are contemplated by and within the scope of the present invention.

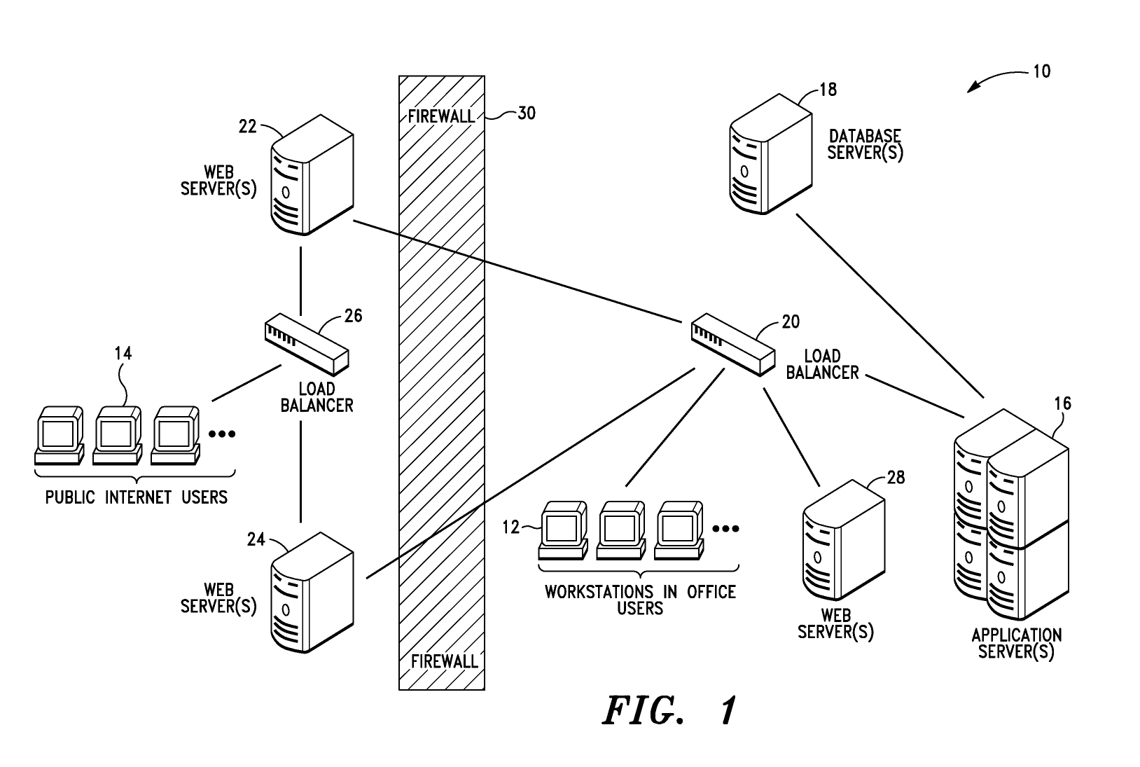

Referring to FIG. 1, a system in accordance with an exemplary embodiment of the present invention is shown generally as reference numeral 10. System 10 includes one or more workstations 12 for use by workers located in an office, such as a secretary of state office. Workstations 12 may comprise any suitable computing system (such as a programmed general purpose computer, a special purpose computer, or the like). One or more peripheral devices may also be provided, such as a display device, a standard keyboard, a mouse, a scanner, a barcode reader for scanning the barcode on a paper document, a magnetic stripe reader for scanning identification or access cards (such as employee identification/access cards used for security purposes), and/or a printer for printing an electronic record that is stored in the system. System 10 also includes computers 14 used by external workers or other users who are permitted to access the system from a remote location using public interact and VPN technologies known in the art.

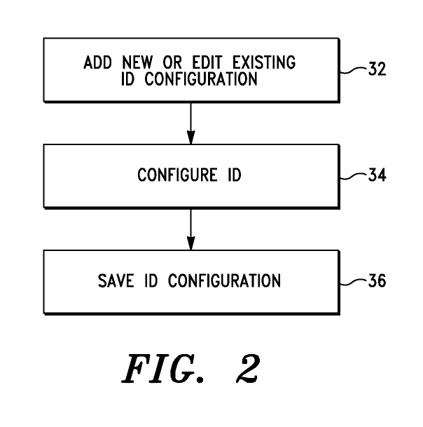

System 10 also includes one or more centralized application servers 16 each of which hosts and runs one or more applications in accordance with the present invention. One application presents a user interface to enable a user to create or edit identification code configurations, as described below in connection with FIGS. 2-5. The same application or another application enables a user to generate an identification code for an electronic record using the appropriate identification code configuration and store the identification code in association with the electronic record. For simplicity, the term “application server” as used herein means both the hardware (i.e., any computing device in which a processor is operable to execute computer-readable instructions stored on a computer-readable medium) and the application(s) that reside thereon.

System 10 further includes one or more centralized database servers 18 each of which stores various types of data, such as identification code configurations, electronic records, identification codes, and other information relevant to identification code configurations (e.g., a system date, a sequential number, a batch designation, a character string, a user designation such as a user ID, an organization designation, a file designation, a document designation, a party designation, a matter designation, a folder designation, a system time, a payment designation, a filing method, a request type, and a product type). For simplicity, the term “database server” as used herein means both the hardware (i.e., any storage device or memory operable to store and provide access to data) and the data stored therein. It should be understood that the data may be stored in a database or any other type of data storage structure known in the art. For example, all or a portion of the data may be stored as a variable on the system in files of various types, such as XML files, flat files, fixed length files, delimited files, batch files, application configuration files, and a wide variety of other file types known in the art.

Several types of computer network connections may be used to network the various components of system 10, including a local area network (LAN), a wide area network (WAN), and other network topologies known in the art. In the illustrated example, a load balancer/router 20 functions to route network traffic between workstations 12 and the application servers 16 and database servers 18. In addition, remote computers 14 located outside of the network may access the application servers 16 and database servers 18 through external web servers 22 and 24 and a load balancer/router 26 that are connected to an internal web server 28 through any suitable firewall 30. Alternatively, remote computers 14 could access application servers 16 and database servers 18 directly through firewall 30 (via an appropriate network configuration), through a series of external web servers, through a VPN connection, or through any other technologies known in the art.

System 10 described above and shown in FIG. 1 is merely an example of a network architecture that may be used to implement the present invention. One skilled in the art will understand that other network architectures may also be used, including a more decentralized model in which the application server(s) and/or database server(s) are only accessible from specific workstations or where the functionality is distributed so that it actually resides on the client workstations in a client application type of model. Also, the application servers and database servers may be replaced with one or more servers that perform both the application and data storage functions described above. Thus, the system may be implemented with any number of servers without departing from the scope of the present invention.

Electronic records, such as those maintained by a secretary of state office, are created and updated in a number of ways depending on how the information is received or processed. For example, a trademark application may be submitted online through a web-based filing or processing system. The applicant initially provides certain information, such as the applicant's name, the applicant's residence address, and the proposed trademark. When the application is submitted, an electronic record for that application is created and stored in database server(s) 18. The application's electronic record includes the information initially entered by the applicant and may include additional information generated at the time of submission, such as a unique application number and filing date.

If the application was submitted correctly, a notification may be generated and sent to the applicant confirming receipt of the application. Information about that notification, such as date and time sent, may be stored in the application's electronic record. As the application is examined by an office employee, certain information may be added to the electronic record such as registration numbers for trademarks similar to the proposed mark. Once examination is complete, further information may be added to the electronic record such as a registration number or final notification information (indicating registration or rejection, for example).

Much of the information described above may be automatically generated and added to the electronic record for the application and some information may be manually entered into the electronic record by the office employee. Regardless of how the electronic record is created or updated, an identification code configuration may be used to generate an identification code for that electronic record. In the example given above, the application's electronic record may have an identification code that incorporates the application number and filing date. Any portion of that electronic record may also be assigned an identification code. For example, the applicant may be assigned an identification code that incorporates the applicant's name and state of residence. This identification code may in turn be incorporated into the identification code associated with the application's electronic record or the identification code for any other electronic records relating to this particular applicant. By way of another example, an identification code may be assigned to each of the notifications that were sent to the applicant. Each of these identification codes may include information about the type of notice (such as acceptance, registration, or rejection).

It should be understood that the above example is provided only for the purpose of illustrating the types of identification codes that may be configured in accordance with the present invention, as described below. One skilled in the art will understand that the number of different types of identification codes are limitless and that the information provided in an identification code can vary from configuration to configuration.

Referring now to FIG. 2, a process flow diagram that shows an exemplary method of creating or editing an identification code configuration using system 10 of FIG. 1 is provided. Each identification code configuration is created or edited by a system user and preferably by an administrator so that the configurations are in accordance with organization policy and rules with respect to which information is included in the identification codes and how the information is to appear. Alternatively, a user other than an administrator may create or edit an identification code configuration under a variety of circumstances. For example, a user may be prompted to create a new identification code configuration when an electronic record is added to system 10. This may occur in circumstances where there is no existing identification code configuration for a particular electronic record type, or, where a user chooses to override an existing identification code configuration for a particular electronic record type. In another example, commonly used identification code configurations that have been pre-configured for use across different systems may be available for a user to select and add to the system. In this case, the identification code configurations would be configured in accordance with the process shown in FIG. 2 and provided in the application code. Preferably, a user has the ability to edit these pre-configured identification code configurations.

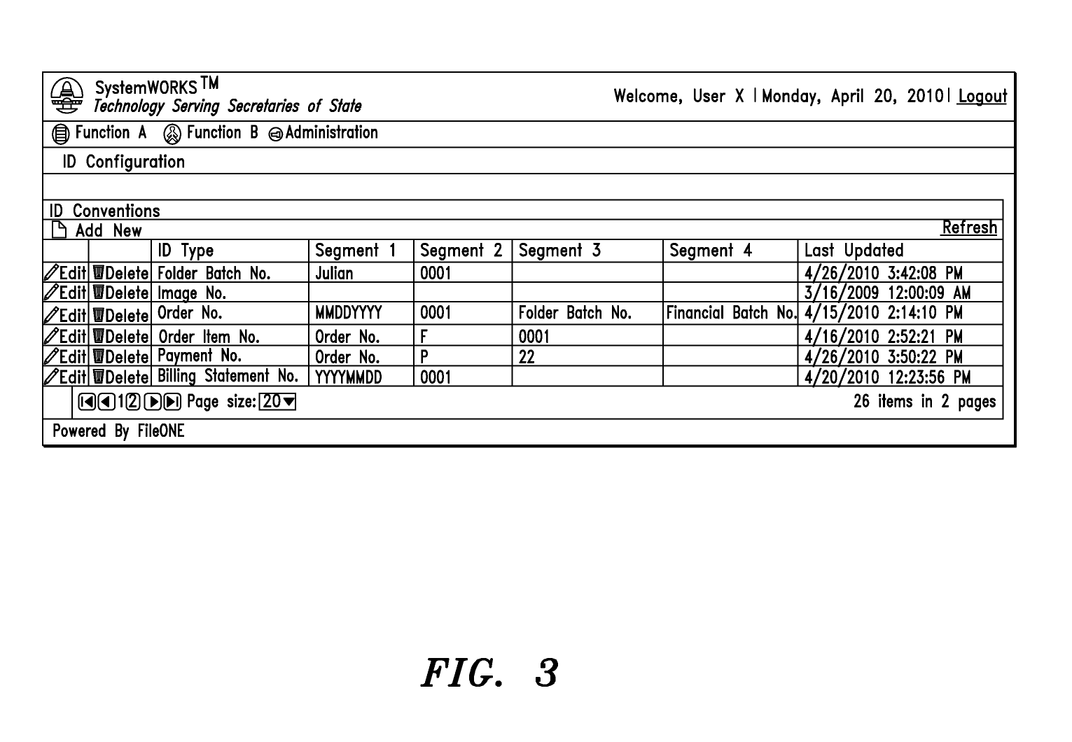

With reference to FIG. 2 at block 32, the software residing on application server(s) 16 presents a user interface that enables the user (e.g., via one of workstations 12 or remote computers 14) to either add a new identification code configuration to a database on database server(s) 18 or edit an existing identification code configuration stored in a database on database server(s) 18. An exemplary “ID Configuration” summary screen that may be displayed on the user's display screen is shown in FIG. 3. From this screen, the user may choose to create a new identification code configuration by selecting an “Add New” button or may edit an existing identification code configuration by selecting an “Edit” button associated with the existing identification code configuration. The term “button” in this context, and as it is used throughout the specification, may be any shape, including a pencil shape as shown in FIG. 3. Alternatively, any other method known in the art such as a hyperlink, voice command, or set of keyboard commands, may be used to execute the desired feature. The user may also delete an identification code configuration by selecting a “Delete” button such as a trash receptacle icon as shown in FIG. 3.

As will be described below, when the user creates a new identification code configuration or edits an existing identification code configuration, she makes selections for various characteristics of the identification code configuration (referred to as “identification code characteristics” and “identification code characteristic selections”). The identification code characteristics include information that allows a user to identify the type of identification code configuration (referred to as “identification code type”), the information to be included in each of the segments that make up the identification code (referred to as “information segments”), and information about the character or space (or lack thereof) that separate adjacent information segments in the identification code (referred to as “separators”).

The screen shown in FIG. 3 displays summaries of identification code configurations currently stored in database server(s) 18. Each summary includes the user's selections for the identification code type and certain information segments. Each summary also includes the date and time that the identification code configuration was last updated. Of course, it should be understood that the summaries may include any or all of the identification code characteristics associated with the identification code configurations stored in a database on database server(s) 18.

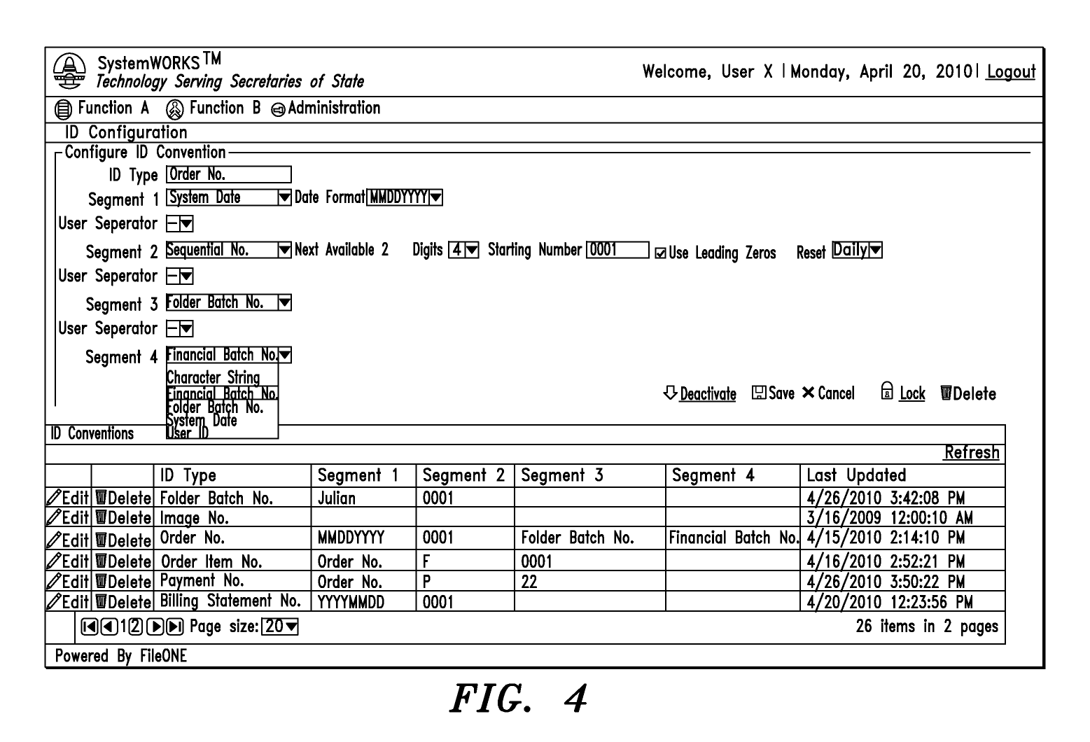

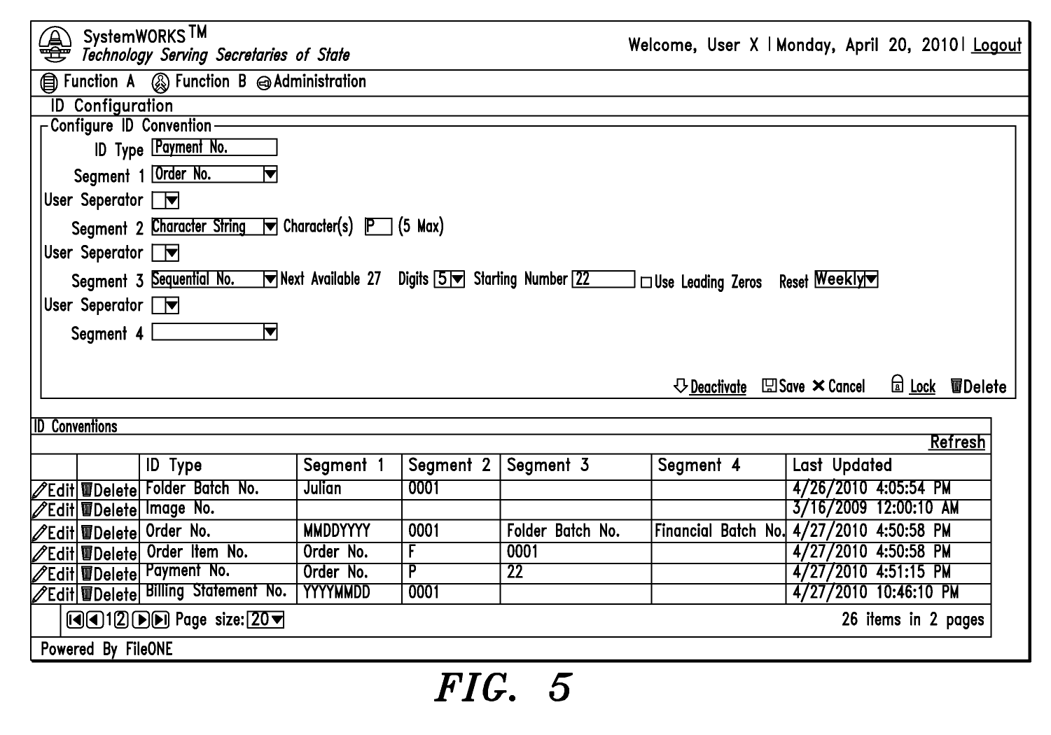

With reference to FIG. 2 at block 34, the user first provides a description of the identification code configuration by making a selection for the identification code type. Exemplary “Configure ID Convention” screens that may be displayed on the user's display screen are shown in FIGS. 4 and 5. As can be seen, the identification code type in this example is the name of the identification code configuration, which is selected by the user by entering a text entry into a text box. In FIG. 4, the user has entered “Order No.” and in FIG. 5 the user has entered “Payment No.” as the identification code type selection. Selections for other identification code types may include, without limitation, the office in which the identification code configuration is to be used, the line of business in which the identification code configuration is to be used, and the electronic record type on which the identification code configuration is to be used.

Identification code configurations may be created for all electronic records in a certain line of business, such as all electronic records relating to liens, business entities, trademarks, or taxes. Alternatively, identification code configurations may be created for each different electronic record type within a line of business. For example, in the trademark line of business, different identification code configurations could be created for electronic records associated with applications, registration certificates, fee payments, and renewals. When multiple identification code configuration levels are created (e.g., a default configuration and at least one line of business configuration or at least one electronic record type configuration), preferences may be set to determine which level of identification code configuration should take precedence and be applied to a particular electronic record. For example, an office preference may be that the default identification code configuration is used unless there is an electronic record type configuration available, or in another example, a line of business level configuration is used unless there is an electronic record type configuration available. It can be appreciated that the present invention allows a user to create a variety of different identification code configurations as desired for a particular office or organization.

With further reference to block 34 of FIG. 2, the user next designates the information to be provided in the identification code by making selections for each of the information segments. Each information segment corresponds to a numbered position that indicates the order in which the information segment selections will appear in the identification code once it is generated for a particular electronic record. As shown in the exemplary “Configure ID Convention” screens of FIGS. 4 and 5, the user selection for each information segment is made by selecting an option from a drop-down menu of pre-determined options.

As shown in FIG. 4, information segments one through four of the identification code have been configured (i.e., user selections have been made for the first four segments) for the Order No. identification code configuration. As can be seen, a system date (e.g., any date entered into or captured by the system, including, but not limited to a filing date, arrival date, process date, completion date, payment date, application date, renewal date, expiration date, or registration date) has been selected for position one of the identification code; a sequential number has been selected for position two of the identification code, a folder batch designation (e.g., a number given to related electronic records organized in a single batch, which may include, for example, electronic records relating to a particular entity or processing period) has been selected for position three of the identification code; and a financial batch designation (e.g., a number given to related electronic records organized in a single hatch, which may include, for example, electronic records relating to a particular financial transaction or processing period) has been selected for position four of the identification code.

With reference to FIG. 5, another exemplary “Configure ID Convention” screen that may be displayed on the user's display screen is shown. In FIG. 5, information segments one through three have been configured for the Payment No. identification code configuration. As can be seen, an order number has been selected for position one of the identification code; a character string has been selected for position two of the identification code; and a sequential number has been selected for position three of the identification code.

Additional pre-determined options for the information segments include a user ID (e.g., any, name, number, or other code that identifies a system user), an organization designation (e.g., name, number, or other identifying code), a name (e.g., a client, customer, or other relevant party), a file designation, a customer designation, a matter designation, a folder designation, a document designation, an invoice number, a receipt number, a system time (e.g., any time entered into or captured by the system, including, but not limited to, a filing time, an arrival time, a process time, a completion time, a payment time, an application time, or a registration time), a payment type, a payment method, a filing method, a request type, a product type, a registration number, or an application number. The pre-determined options available for each information segment may vary by position. For example, a user ID may be a pre-determined option for position four but not position one of the identification code.

Although only four information segments are shown in FIGS. 4 and 5, any number of information segments may be provided for an identification code configuration. Additional information segments may be automatically added to an identification code configuration as a selection for the information segment in the last available position is made or when the user selects an appropriate button such as “Add Information Segment” (not shown).

Depending on the selection received for each information segment, further identification code characteristics relating to the information segment may be presented in the identification code configuration. For example, if system date is selected for an information segment, then the user may select the date format in which the date will appear. As shown in FIG. 4 at position one, the user has configured the system date to appear in a two-digit month, two-digit day, and four-digit year format (MMDDYYYY). Other date formats include DDMMYYYY; YYYYMMDD; YYYYDDMM; MMDDYY; DDMMYY; YYMMDD; YYDDMM; MONTH NAME DD, YYYY; OR DD MONTH NAME YYYY; YYYY; YY; MM; and DD.

If a sequential number is selected for an information segment, then the user may further configure the following: the number of digits included in the number; the starting number; whether to use leading zeros; and how often the counter is reset, i.e., the reset period. Any number of digits for a sequential number and any starting number may be designated. The options for resetting the sequential number counter may include any time period such as hourly, daily, weekly, monthly, quarterly or yearly. Other options for resetting the sequential number counter include an automatic reset on a particular date or a manual reset. The sequential number counter may be manually reset by selecting a “Reset” button (not shown). The sequential number counter may also be manually reset by editing the configuration and saving the edited configuration. As shown in FIGS. 4 and 5, the selections for the number of digits in the sequential number and the reset period are made from a drop-down menu displaying pre-determined options, the selection for the starting number is made by a text entry in a text box, and the selection for use of leading zeros in the sequential number is made by checking a checkbox. Moreover, all information segments comprising a number, such as a financial batch number or folder batch number, could be further configured in the manner described above with respect to the sequential number.

As shown in FIG. 4 at position two of the Order No. identification code configuration, the user has configured the sequential number to be four digits in size, starting at 0001. The user has also chosen to use leading zeros and has configured the sequential numbering segment of the identification code to reset daily. As shown in FIG. 5 at position three of the Payment No. identification code configuration, the user has configured the sequential number to be five digits in size, starting at 22. The user has chosen not to use leading zeros and has configured the sequential numbering segment of the identification code configuration to reset weekly. In addition, the next available number, i.e., the lowest number that has not already been incorporated into an identification code, may be indicated. As shown in FIG. 4, the next available number is “2,” which will be displayed in the identification code as 0002. As shown in FIG. 5, the next available number is “27,” which will be displayed in the identification code as 27.

If character string is selected as an information segment, the user makes the appropriate selection by entering one or more characters (numbers, letters, symbols, or blank spaces) that will appear at the designated position in each identification code generated using that same configuration. As shown in FIG. 5 at position two, the user has entered the letter “P” as the character string. In this embodiment, the character string is limited to five characters, although any number of characters could be used. The character string is preferably meaningful in that it will provide information about the electronic record without having to view or access the electronic record with which the identification code is associated. For example, if the convention is that “P” means payment, then when a “P” appears in an identification code, a person familiar with the identification code configuration would know that the electronic record is a payment without having to access the electronic record.

As shown in FIG. 4, the user has configured the Order No. identification code configuration such that a folder batch number appears in position three and a financial batch number appears in position four. Thus, when an order is placed, entered, or generated by system 10, an Order No. identification code will be generated and associated with the corresponding order. The identification code will include the financial batch number and folder batch number to which that order relates, which will enable a user to quickly locate the underlying electronic record or related electronic records.

It should be understood that the information required by a particular identification code configuration (i.e., the information in the information segments) will be obtained from various sources. Some information will be entered by the user or obtained from an electronic record stored in a database on database server(s) 18. Other information may comprise general information that could apply to a number of electronic records (e.g., the current date, the current time, an office name or location, or a user ID). Still other information will be automatically generated using appropriate algorithms based on information stored in one or more electronic records or elsewhere in system 10. For example, a checksum figure or sequential number may be generated. Many identification code configurations will require a combination of two or more of these information source options. No matter the source of information, the application server(s) 16 retrieve information corresponding to the selected information segments and incorporate the information into the identification code in accordance with the identification code configuration.

In addition to receiving selections for the information segments in the identification code configuration, selections relating to the inclusion and type of separators between adjacent information segments are received during the configuration process. Separators may be any character, including, but not limited to, a dash, a plus sign, an ampersand, a slash, a dot, an asterisk, a space, a number, a letter, a symbol, a blank space or any combination thereof. As shown in FIG. 4, a dash has been selected as the separator between information segments one and two, information segments two and three, and information segments three and four. Of course, no separator need be used at all, in which case the information segments would appear contiguous in the identification code. As shown in FIG. 5, no separator has been selected for use between information segments one and two or information segments two and three.

It should be understood that any method known in the art for displaying any of the identification code characteristics and receiving identification code characteristic selections may be used. For example, an identification code characteristic may be displayed in association with a text box, in which case the selection is a text entry entered by a user in the text box (as described above with reference to the identification code type). An identification code characteristic may also be displayed in association with a check box, in which case the selection is a check entered by a user in the checkbox (as described above with reference to the leading zeros in a sequential number). In addition, an identification code characteristic may be displayed in associated with one or more pre-determined options, in which case the selection is a selection made by a user from the Ore-determined options (as described above with reference to the information segments and separators). Other selection methods may include marking a circle or radio button, actuating a button, or selecting indicators such as “yes” or “no,” or “on” or “off” for each identification code characteristic.

With reference to FIG. 2 at block 36, the user saves the identification code configuration once she has made selections for all of the desired identification code characteristics. As shown in FIGS. 4 and 5, the identification code configuration is saved to database server(s) 18 by selecting a “save” button, such as a disc icon. The user may also deactivate the identification code configuration, lock the identification code configuration to prevent editing by another user, or cancel the identification code configuration (i.e., exit without saving) by selecting the appropriate button.

With reference to FIG. 2 at blocks 32 and 34, the user may alternatively choose to edit an existing identification code configuration. If the user chooses to edit an existing identification code configuration, the previous selections for the identification code type, information segments, and separators, will be displayed in a format similar to the one shown in FIGS. 4 and 5. The user may make the appropriate edits and then select a “save” button to save her changes to that particular identification code configuration. Likewise, the user may cancel her changes by selecting a “cancel” button such as an “X” icon as shown in FIGS. 4 and 5. The user may also have the option to deactivate a configuration, lock a configuration, or delete a configuration altogether by selecting an appropriate button.

In another aspect of the present invention, an identification code can be generated for an electronic record using the appropriate identification code configuration. In an exemplary embodiment, an application residing on application server(s) 16 is used to generate an identification code for an electronic record by retrieving the appropriate identification code configuration, using the identification code configuration to generate the identification code, and storing the identification code in association with the electronic record in database server(s) 18. For example, with reference to FIG. 4, the Order No. identification code configuration has the following customized configuration: system date (MMDDYYYY)—sequential number (starting at 0001 and reset daily)—folder batch number—financial batch number. If an order is created in system 10 on Apr. 26, 2010 and is associated with folder batch number 1234 and financial batch number 6789, the corresponding identification code will be 04262010-0002-1234-6789. Thus, upon viewing the identification code alone (without viewing or accessing the underlying order), someone familiar with the identification code configuration convention would know that the order was created on Apr. 26, 2010, it was the second order of the day, and the order is part of folder batch 1234 and financial batch 6789. Similarly, if another order is created on that same day and is associated with folder batch 1212 and financial batch 3434, the identification code will be 04262010-0003-1212-3434. Thus, upon viewing the identification code alone, someone familiar with the identification code configuration convention would know that the order was created on Apr. 26, 2010, it was the third order of the day, and the order is part of folder 1212 and financial batch 3434.

As another example, with reference to FIG. 5, the Payment No. identification code configuration has the following customized configuration: order number character string (P) sequential number (starting at 22 and reset weekly). If a payment created in system 10 on Apr. 28, 2010 is associated with order number 4545, the corresponding ID will be 4545P27. Thus, upon viewing the identification code alone (without viewing or accessing the underlying payment), someone familiar with the identification code configuration convention would know that the electronic record is a payment for order number 4545, and it was the sixth payment of the week. Similarly, if a second payment associated with order number 6767 is created in system 10 within the same week as the Apr. 28, 2010 payment previously discussed, the corresponding identification code will be 6767P28.

The identification code generated for an electronic record may appear on a physical or electronic version of the electronic record (i.e., when the electronic record is printed or viewed on a display screen) or may appear in another electronic record (e.g., an invoice) as a reference to the electronic record with which the identification code is associated. An identification code for one electronic record may be included as an information segment in an identification code for another electronic record. Alternatively, the identification code may be included in an electronic stamp as disclosed in U.S. patent application Ser. No. 13/073,411 assigned to the assignee of the present application. The identification code may also appear on physical objects. For example, when a paper document is received by the office, an electronic record of the document may be created in the information management system by manual entry or by using scanning and OCR technologies. The identification code generated using the information in the electronic record and the appropriate identification code configuration may be encoded in a barcode or presented in any other machine-readable or human-readable form, such as alphanumeric form, and affixed to the paper document.

While the present invention has been described and illustrated hereinabove with reference to an exemplary embodiment, it should be understood that various modifications could be made to this embodiment without departing from the scope of the invention. Therefore, the invention is not to be limited to the exemplary embodiment described and illustrated hereinabove, except insofar as such limitations are included in the following claims.

What is claimed and desired to be secured by Letters Patent is as follows:

1. A computer-implemented method for configuring identification codes associated with electronic records, comprising:
providing a user interface that enables a user to create or edit an identification code configuration by displaying a plurality of identification code characteristics and receiving a plurality of identification code characteristic selections corresponding to said identification code characteristics;
storing said identification code characteristic selections so as to define said identification code configuration; and
using said identification code configuration to generate an identification code for an electronic record, wherein said identification code is configured to provide information about said electronic record.

2. The computer-implemented method of claim 1, further comprising storing said identification code in association with said electronic record.

3. The computer-implemented method of claim 1, wherein said information in said identification code enables location of said electronic record.

4. The computer-implemented method of claim 1, wherein said information in said identification code enables location of one or more additional electronic records related to said electronic record.

5. The computer-implemented method of claim 1, further comprising retrieving information corresponding to at least one of said identification code characteristic selections and incorporating said information into said identification code in accordance with said identification code configuration.

6. The computer implemented method of claim 1, wherein said identification code characteristics comprise one or more of the following: one or more information segments; one or more separators; and one or more identification code types.

7. The computer-implemented method of claim 6, wherein said information segments comprise one or more of the following: a system date, a sequential number, a batch designation, a character string, a user designation, an organization designation, a party designation, a file designation, a document designation, a matter designation, a folder designation, a system time, a payment designation, a filing method, a request type, and a product type.

8. The computer-implemented method of claim 6, wherein one or more of said information segments comprises a sequential number, and wherein said identification code characteristics further comprise one or more of the following: one or more leading zeros in said sequential number; a number of digits in said sequential number; a starting number for said sequential number; and a reset period for generation of said sequential number.

9. The computer-implemented method of claim 6, wherein one or more of said information segments comprises a character string, and wherein said identification code characteristics further comprise one or more of the following: one or more letters in said character string; one or more numbers in said character string; one or more symbols in said character string; one or more blank spaces in said character string; and combinations thereof.

10. The computer-implemented method of claim 6, wherein one or more of said information segments comprises a system date, and wherein said identification code characteristics further comprise a date format for said system date.

11. The computer-implemented method of claim 6, wherein said identification code type characteristics comprise one or more of the following: an identification code configuration name; an office in which an identification code configuration is used; a line of business in which an identification code configuration is used; and an electronic record type on which an identification code configuration is used.

12. The computer-implemented method of claim 1, wherein said user interface enables said user to create or edit said identification code configuration by displaying one or more pre-determined options associated with at least one of said identification code characteristics.

13. The computer-implemented method of claim 12, wherein at least one of said identification code characteristic selections comprises a selection made by said user from said pre-determined options.

14. The computer-implemented method of claim 1, wherein said user interface enables said user to create or edit said identification code configuration by displaying a text box associated with at least one of said identification code characteristics.

15. The computer-implemented method of claim 14, wherein at least one of said identification code characteristic selections comprises a text entry entered by said user in said text box.

16. The computer-implemented method of claim 1, wherein said user interface enables said user to create or edit said identification code configuration by displaying a checkbox for at least one of said identification code characteristics.

17. The computer-implemented method of claim 16, wherein at least one of said identification code characteristic selections comprises a check entered by said user in said checkbox.

18. The computer-implemented method of claim 1, wherein said user interface enables said user to review a summary of said identification code configuration.

19. The computer-implemented method of claim 18, wherein said summary of said identification code configuration comprises one or more of said identification code characteristics and associated identification code characteristic selections for said identification code configuration.

20. A system for configuring identification codes associated with electronic records, comprising:
at least one database server; and
at least one application server in communication with said database server, wherein said application server:
provides a user interface that enables a user to create or edit an identification code configuration, wherein said user interface (i) displays a plurality of identification code characteristics and (ii) receives a plurality of identification code characteristic selections corresponding to said identification code characteristics;
stores said identification code characteristic selections so as to define said identification code configuration;
uses said identification code configuration to generate an identification code for an electronic record, wherein said identification code is configured to provide information about said electronic record; and
stores said identification code in association with said electronic record in said database server.

21. The system of claim 20, wherein said information in said identification code enables location of said electronic record.

22. The system of claim 20, wherein said information in said identification code enables location of one or more additional electronic records related to said electronic record.

23. The system of claim 20, wherein said application server retrieves information corresponding to at least one of said identification code characteristic selections from said database server and incorporates said information into said identification code in accordance with said identification code configuration.

24. The system of claim 20, wherein said identification code characteristics comprise one or more of the following: one or more information segments; one or more separators; and one or more identification code types.

25. The system of claim 24, wherein said information segments comprise one or more of the following: a system date, a sequential number, a batch designation, a character string, a user designation, an organization designation, a file designation, a document designation, a party designation, a matter designation, a folder designation, a system time, a payment designation, a filing method, a request type, and a product type.

26. The system of claim 24, wherein one or more of said information segments comprises a sequential number, and wherein said identification code characteristics further comprise one or more of the following: one or more leading zeros in said sequential number; a number of digits in said sequential number; a starting number for said sequential number; and a reset period for generation of said sequential number.

27. The system of claim 24, wherein one or more of said information segments comprises a character string, and wherein said identification code characteristics further comprise one or more of the following: one or more letters in said character string; one or more numbers in said character string; one or more symbols in said character string; one or more blank spaces in said character string; and combinations thereof.

28. The system of claim 24, wherein one or more of said information segments comprises a system date, and wherein said identification code characteristics further comprise a date format for said system date.

29. The system of claim 24, wherein said identification code types comprise one or more of the following: an identification code configuration name; an office in which an identification code configuration is used; a line of business in which an identification code configuration is used; and an electronic record type on which an identification code configuration is used.

30. The system of claim 20, wherein said user interface displays one or more pre-determined options associated with at least one of said identification code characteristics.

31. The system of claim 30, wherein at least one of said identification code characteristic selections comprises a selection made by said user from said pre-determined options.

32. The system of claim 20, wherein said user interface displays a text box associated with at least one of said identification code characteristics.

33. The system of claim 32, wherein at least one of said identification code characteristic selections comprises a text entry entered by said user in said text box.

34. The system of claim 20, wherein said user interface displays a checkbox for at least one of said identification code characteristics.

35. The system of claim 34, wherein at least one of said identification code characteristic selections comprises a check entered by said user in said checkbox.

36. The system of claim 20, wherein said user interface displays a summary of said identification code configuration.

37. The system of claim 36, wherein said summary of said identification code configuration comprises one or more of said identification code characteristics and associated identification code characteristic selections for said identification code configuration.

38. The system of claim 20, wherein said database server and said application server comprise a single server.

39. A computer-readable medium having instructions stored thereon for execution by a processor to perform a method for configuring identification codes associated with electronic records, the method comprising:
displaying a plurality of identification code characteristics;
receiving a plurality of identification code characteristic selections corresponding to said identification code characteristics; and
storing said identification code characteristic selections so as to define an identification code configuration.

40. The computer-readable medium of claim 39, further comprising using said identification code configuration to generate an identification code for an electronic record, wherein said identification code is configured to provide information about said electronic record.

41. The computer-readable medium of claim 40, further comprising storing said identification code in association with said electronic record.

42. The computer-readable medium of claim 40, wherein said information in said identification code enables location of said electronic record.

43. The computer-readable medium of claim 40, wherein said information in said identification code enables location of one or more additional electronic records related to said electronic record.

44. The computer-readable medium of claim 40, further comprising retrieving information corresponding to at least one of said identification code characteristic selections and incorporating said information into said identification code in accordance with said identification code configuration.

45. The computer-readable medium of claim 39, wherein said identification code characteristics comprise one or more of the following: one or more information segments; one or more separators; and one or more identification code types.

46. The computer-readable medium of claim 45, wherein said information segments comprise one or more of the following: a system date, a sequential number, a batch designation, a character string, a user designation, an organization designation, a file designation, a document designation, a party designation, a matter designation, a folder designation, a system time, a payment designation, a filing method, a request type, and a product type.

47. The computer-readable medium of claim 45, wherein one or more of said information segments comprises a sequential number, and wherein said identification code characteristics further comprise one or more of the following: one or more leading zeros in said sequential number; a number of digits in said sequential number; a starting number for said sequential number; and a reset period for generation of said sequential number.

48. The computer-readable medium of claim 45, wherein one or more of said information segments comprises a character string, and wherein said identification code characteristics further comprise one or more of the following: one or more letters in said character string; one or more numbers in said character string; one or more symbols in said character string; one or more blank spaces in said character string; and combinations thereof.

49. The computer-readable medium of claim 45, wherein one or more of said information segments comprises a system date, and wherein said identification code characteristics further comprise a date format for said system date.

50. The computer-readable medium of claim 45, wherein said identification code type characteristics comprise one or more of the following: an identification code configuration name; an office in which an identification code configuration is used; a line of business in which an identification code configuration is used; and an electronic record type on which an identification code configuration is used.

51. The computer-readable medium of claim 39, further comprising displaying one or more pre-determined options associated with at least one of said identification code characteristics.

52. The computer-readable medium of claim 51, wherein at least one of said identification code characteristic selections comprises a selection from said pre-determined options.

53. The computer-readable medium of claim 39, further comprising displaying a text box associated with at least one of said identification code characteristics.

54. The computer-readable medium of claim 53, wherein at least one of said identification code characteristic selections comprises a text entry in said text box.

55. The computer-readable medium of claim 39, further comprising displaying a checkbox for at least one of said identification code characteristics.

56. The computer-readable medium of claim 55, wherein at least one of said identification code characteristic selections comprises a check in said checkbox.

57. The computer-readable medium of claim 39, further comprising displaying a summary of said identification code configuration.

58. The computer-readable medium of claim 57, wherein said summary of said identification code configuration comprises one or more of said identification code characteristics and associated identification code characteristic selections for said identification code configuration.
